(19) United States
(12) Patent Application Publication
(10) Pub. No.: US 2026/0187078 A1
(43) Pub. Date: Jul. 2, 2026

(54) IMPROVED METHOD AND SYSTEM FOR PERFORMING APPROXIMATE SEARCH IN DATABASE SYSTEMS

(71) Applicant: Teradata US, Inc., San Diego, CA (US)

(72) Inventors: Paul Geoffrey Brown, Concord, MA (US); Faraz Ahmad, Santa Clara, CA (US)

(73) Assignee: Teradata US, Inc., San Diego, CA (US)

(21) Appl. No.: 19/007,304

(22) Filed: Dec. 31, 2024

(51) Int. Cl. G06F 16/2455; G06F 16/22

(52) U.S. Cl. CPC G06F 16/24558; G06F 16/2255

(57) ABSTRACT

A system and methods for performing approximate search to find approximate matches or similarities between a short character string or token included in a database query and strings/tokens contained within a target database table. A novel Locality Sensitivity Hashing function utilizing a table of common bigrams and accompanying values associated with frequency of occurrence of the bigrams in the English language, compares bigrams contained in search and data strings/tokens to the bigrams contained in the table of common bigrams, generates hash values for search and data string/tokens from the values associated with matching bigrams, and creates a hash table mapping similar strings or tokens together through hash values.

### FIELD OF THE INVENTION

This invention relates generally to Retrieval Augmented (Query) Generation in database systems, or more particularly, to approximate string matching techniques to find approximate matches or similarities between query search targets and database target data.

### BACKGROUND OF THE INVENTION

A relational database management system (DBMS) stores databases that include collections of logically related data arranged in a predetermined format, such as in tables that contain rows and columns. To access the content of a table in a database, queries according to a standard database query language (such as the Structured Query Language or SQL) are submitted to the database. A query can also be issued to insert new entries into a table of a database (such as to insert a row into the table), modify the content of the table, or to delete entries from the table. Examples of SQL statements include INSERT, SELECT, UPDATE, and DELETE.

A query received by the database management system is processed by the DBMS to generate a query plan, which is a series of operations the DBMS will execute to locate data matching the query within the database. One such operation may be the retrieval of data records containing a search target, such as a token or word provided in a query submitted by a user. For example, target data to be searched within a database may be personal names, place names, department names, etc., and the search target may be a user-provided string such as “Reagan”, “Oregon”, “Rolling Stones”, etc.

Within database systems, approximate search algorithms may be employed to find approximate matches or similarities in data and provide the ability to perform predictive search functions, detect misspellings, or return approximate values. Discussed herein is an implementation of a version of approximate search for matching strings/tokens in target data and minor transliterations of the search string the user intended to type. For example, a user prompt including misspellings such as “RReagan”, “Arkansah” and “Rolling Stone” will be matched with the most similar string in the target data.

### BRIEF DESCRIPTION OF THE DRAWINGS

Some implementations of the present disclosure are described with respect to the following figures.

FIG. 1 is a block diagram of a database system arrangement including a database management system and connected data storage.

FIG. 2 provides a simple example of an approximate search operation to locate in, and retrieve data from, a database table.

FIG. 3 is a flow diagram illustrating the use of Locality Sensitive Hashing to hash similar data strings/tokens into hash buckets, and matching input strings/tokens with hash buckets.

FIG. 4 provides a high-level illustration of a Locality Sensitive Hashing procedure which utilizes a list of bigrams to generate hash values for short strings or tokens in accordance with the present invention.

FIG. 5 provides a flow diagram illustrating the structure and operation of a Locality Sensitive Hashing process and bigram table frequency table to generate a hash value for a short string or token in accordance with the present invention.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION OF THE INVENTION

In the present disclosure, use of the term “a,” “an,” or “the” is intended to include the plural forms as well, unless the context clearly indicates otherwise. Also, the terms “includes,” “including,” “comprises,” “comprising,” “have,” or “having” when used in this disclosure specifies the presence of the stated elements, but do not preclude the presence or addition of other elements.

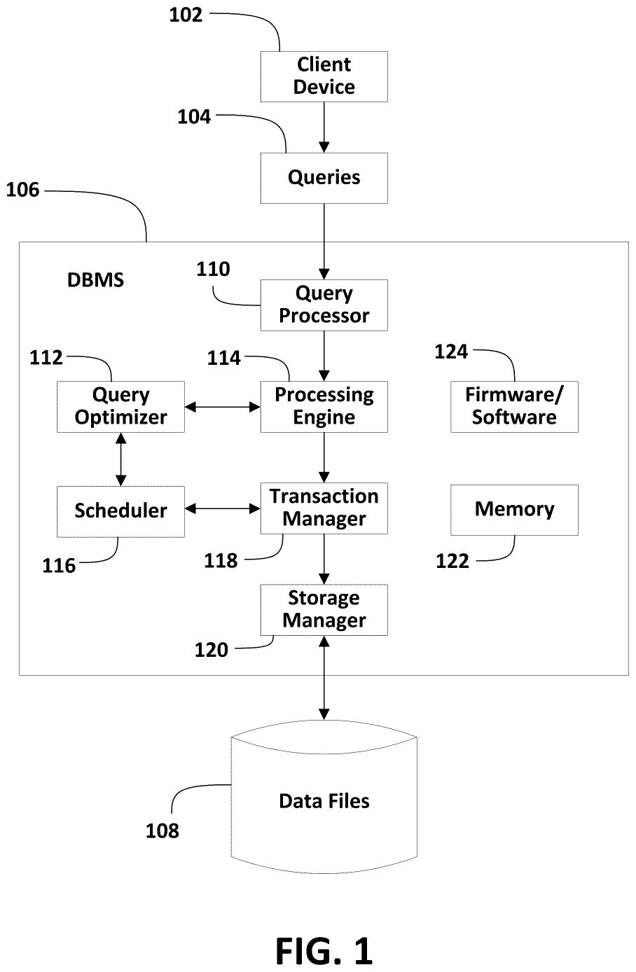

FIG. 1 is a block diagram of an example database system arrangement that includes one or more client devices for submitting database queries to a database management system (DBMS) 106 and a connected data store 108.

In some examples, data store 108 may be a cloud data store. A “cloud” can refer to any infrastructure, including computing, storage, and communication resources, that can be accessed remotely by user devices over a network. Alternatively, data store 108 can be provided in a data center or in any other computing environment.

The network can include a public network, (e.g., the Internet), a local area network (LAN), a wide area network (WAN), a wireless network (e.g., a wireless local area the network or WLAN, a cellular network, etc.), or any other type of network.

The cloud data store may be a remote object store. For example, the remote object store can be according to any of the following: Simple Storage Service (S3) from AMAZON WEB SERVICES (AWS), Google Cloud Storage, Microsoft AZURE, and so forth.

Traditionally, a DBMS stores data of tables in a block-based storage. A “table” can refer to a relational table of a database created to store specific data records.

In some examples, a block-based storage can include disk-based storage devices, solid state storage devices, and so forth. The block-based storage can be connected to the DBMS over a relatively high-speed link, such that the DBMS can access (read or write) data in a relational database with relatively low input/output (I/O) latency (i.e., the delay between a time that a request is submitted and a time that the request is satisfied at the storage is relatively low). The block-based storage can be considered a local storage of the DBMS, since the DBMS is able to access the block-based storage with relatively low I/O latency.

As further shown in FIG. 1, DBMS 106 includes a query processor 110 that is able to process database queries (e.g., SQL queries) 104, including data definition language (DDL) statements and data manipulation language (DML) statements. The query processor 110 can include an optimizer 112 that can produce a query plan including database operations to be executed for processing a given database query.

In addition to the query processor 110, the DBMS 106 includes one or more processing engines 114 to execute database operations of a query plan, a scheduler 116 and transaction manager 118 for scheduling and managing database operations specified in the query plan, and a storage manager 120 providing an interface between the RDMS and data storage 108. Storage manager 120 is responsible for updating, storing, deleting, and retrieving data in the database.

Database queries 104 can be submitted by one or more client devices 102 to the DBMS 106. The client devices 102 can include any or some combination of the following: a server computer, a desktop computer, a notebook computer, a tablet computer, a smartphone, a game appliance, a vehicle, a household appliance, or any other type of electronic device.

The DBMS 106 further includes a memory 122. A memory can be implemented using one or more memory devices. A memory device can include a volatile memory device, such as a dynamic random access memory (DRAM) device, a static random access memory (SRAM) device, and so forth. Alternatively, a memory device can include a nonvolatile memory device, such as a flash memory device, or any other type of nonvolatile memory device. Although shown as a single block, note that the memory 122 can be distributed as multiple memories in association with the processing engines 114.

The DBMS further includes firmware and software 124 comprising system, utility, and possibly application software.

As stated above, database systems may employ approximate search algorithms, also referred to as fuzzy string or similarity search algorithms, to find approximate matches or similarities between query search targets and database target data.

### Approximate Search Using an LSH Function for Short Strings/Tokens

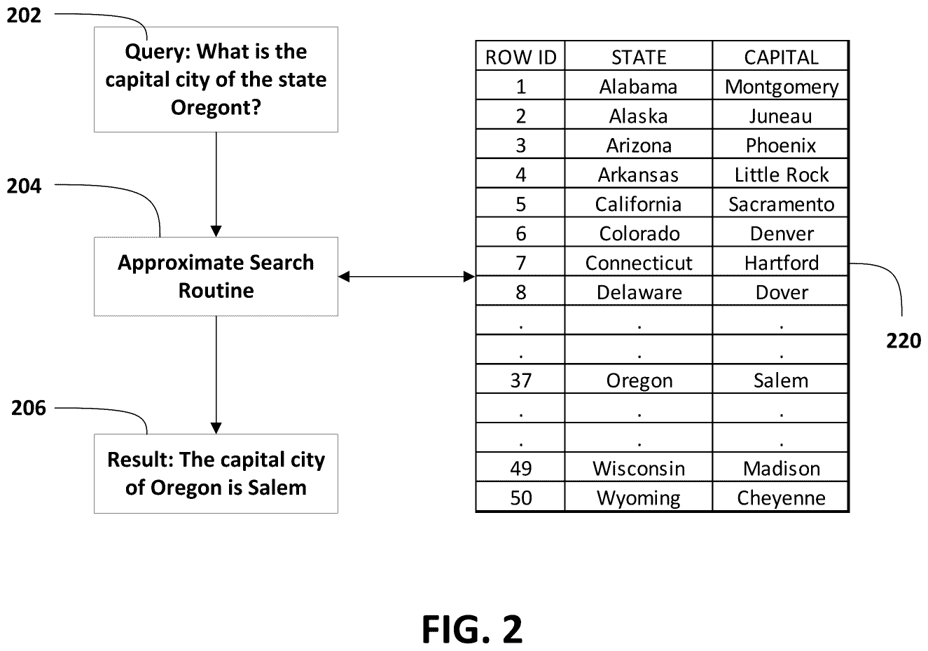

FIG. 2 provides a simple example of an approximate search operation wherein a query 202 including a state name is submitted to a database system to retrieve the name of the state's capital city from a database table 220 containing a list of state names and respective capital city names. In this example, the query 202 search target, intended to be the state name “OREGON,” has been misspelled as ‘OREGONT”. An approximate search routine 204 is employed to search for a state name in database 220 which is most similar to the search target “OREGONT.” In this example, the approximate search routine will identify the state name “OREGON” from table 220 and the capital city name “SALEM” will be returned as a query result 206.

Presented herein is an improved version of an approximate search system and method wherein the target data to be searched consists of a moderately large collection of short strings or tokens, e.g., words or naming labels such as personal names, place names, department names, etc., and the search target may be a user-provided string; such as “Reagan”, “Oregon”, “Rolling Stones”. Approximate search provides for the matching of strings/tokens in the target data with minor transliterations of the search string the user intended to type. For example, minor transliterations included in a user query search target, such as “RReagan”, “Oregont” and “Rolling Stone,” will each match with a similar string intended by the user.

As used herein, a transliteration of any short string or token is another short string or token created by inserting or deleting a small number of characters. For example, the strings ‘red’, ‘Fredd’, and ‘Frde’ are all transliterations of the strings ‘Fred’. By contrast, the string “Barney” would not be a transliteration of “Fred” because the number of character differences between “Barney” and “Fred” is excessive.

The solution described herein involves the use of Locality Sensitive Hashing (LSH) which is a technique used in computer science to hash similar input items (target strings/takens) into the same output hash buckets with high probability, e.g., the hash value of “Reagan”, represented as LSH(“Reagan”), =LSH(“RReagan”), and does not equal any of LSH({“Oregon”, “Oregont”, “Rolling Stones”, “Rolling Stone”}). An important constraint on Locality Sensitive Hashing methods is that the LSH methods are inherently probabilistic. That is, the method never guarantees that LSH(string)=LSH(close_string). Rather, the result of any LSH function is LSH(string)=LSH(close_string) with acceptable probability.

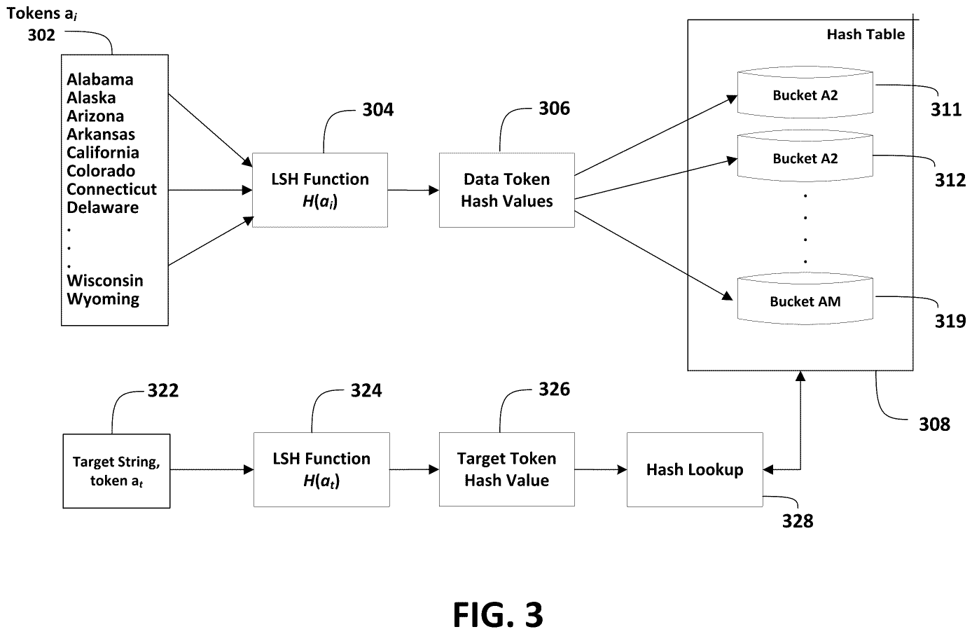

FIG. 3 provides an illustration of the use of Locality Sensitive Hashing to hash similar data strings/tokens into hash buckets, and matching input strings/tokens with hash buckets. Referring to FIG. 3, a list of data strings/tokens 302 is processed through an LSH function 304 to generate hash values 306 for the data strings/tokens 302. In this example, the data strings/tokens 302 is a list of state names, such as the list of state names from table 220 of FIG. 2. Individual data strings/tokens are identified with the nomenclature aᵢ, wherein i ranges from 1 through N. The FSH function applied to data strings/tokens aᵢ is identified as H(aᵢ).

The hashing function 304 is used to convert the data string/tokens (aᵢ) into fixed-size binary (bytes and bits) output hash values 306. The hash function must be deterministic, which guarantees that it will always yield the same result for a given input. The data strings/tokens aᵢ (or token IDs) and hash values 306 are stored in an array of buckets or slots 311 through 319 within a hash table 308. Hash buckets 311 through 319 are used to apportion data strings/tokens for sorting or lookup purposes. With the hash values functioning as an index into hash table 308 and buckets 311 through 319.

A search string/token aₜ 322 included in a query provided by a user is processed through the LSH function, now identified by reference numeral 324, to generate a hash value 306 for the search string/token aₜ. The FSH function applied to search strings/tokens aₜ is identified as H(aₜ). A hash lookup operation 328 utilizes the hash value 326 generated from search string/token 322 to locate and retrieve similar token/string values from the hash table bucket 311 through 319 associated with target token hash value 326.

In the example of LSH hashing illustrated in FIG. 3, the list of data strings/tokens is drawn from one data element or column within a database table, however, this list of data strings/tokens may be taken from one of more data elements or columns within a database table or database object.

The approximate search system and method described herein employs a novel LSH function that relies on the frequency distribution of bigrams in the English written vocabulary to generate hash values for input strings or tokens. A bigram, as used herein, is a sequence of two adjacent characters from a string or token. This bigram method may also be used with alphabetic and phonetic writing systems other than English.

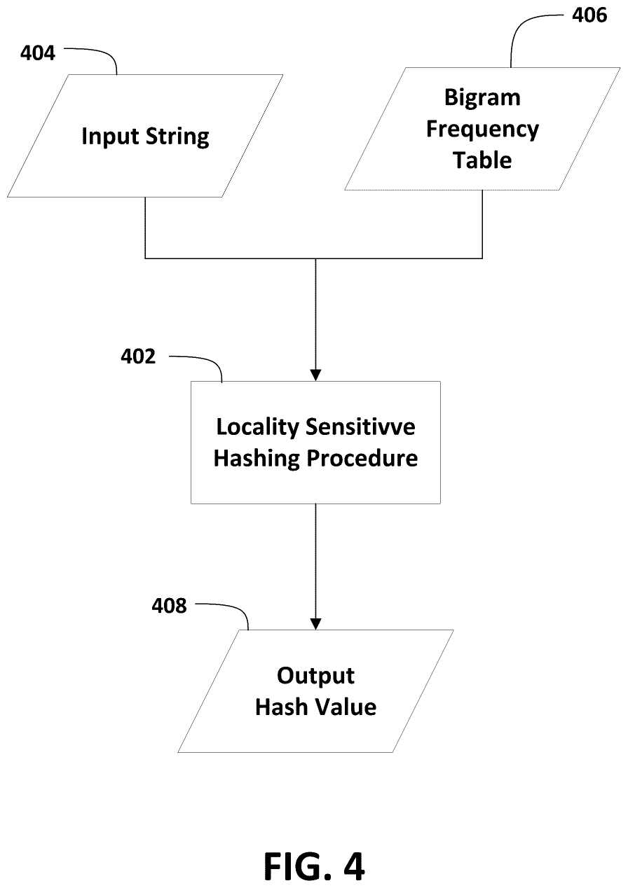

FIG. 4 provides a high-level illustration of the LSH hashing procedure 402 which receives as input an input string 404 and a list of bigrams from table 406 to generate hash values 408 for input strings or tokens. An input string 404 may be a data string/token from a database table or other data source or a string/token included in a user query. Additional details regarding LSH hashing procedure 402 and bigram frequency table are provided below.

The novel LSH function described below is particularly useful when performing an approximate search of a database, or corpus, that includes numerous data elements, e,g., columns in tables, or fields in files, that contain a small set of tokens or short strings; and given a user prompt in the form of another short string (target), a user wants to identify, with high probability, whether that target short string or some close transliteration of it is found in a particular data element. Another way to frame the problem is to ask “Which data elements contain a string that is a close transliteration of the target string?”

The novel LSH function presented here was conceived to efficiently answer the type of question presented above. Subsequent to combining all of the tokens from all of the data elements to be searched into a single list of <token, Data Element ID>pairs, the LSH function is used to partition the tokens into groups and record in each partition the set of Data Element IDs for similar data elements that contributed a token to that partition. Then given a token (target token) to be searched for, the LSH function is used in determining which groups of data elements contain a similar token to the target token.

The novel Locality Sensitive Hashing (LSH) discussed herein works in the context of individual tokens or short strings. Consider a set of N tokens identified as A, with individual tokens within A labeled a₁, a₂, a₄ . . . aₙ. When looking at any pair of these tokens (aᵢ, aⱼ), a number of methods can be used to compute a distance between the paired tokens. Ideally, such a distance function D(aᵢ, aⱼ) needs to possess a couple of properties; for instance, triangle inequality needs to hold. That is, D(aᵢ, aₖ)<=D(aᵢ, aⱼ)+D(aⱼ, aₖ). The goal is to start with some aᵢ token (a target token supplied by a user) and compute A′⊂A, where ∀aⱼ∈A′, D(aᵢ, aⱼ)<d_{threshold}, with probability p. That is, starting with a search token aᵢ, finding (quickly) the tokens in the search list A where the search list token is “close” to the target token.

Locality Sensitive Hashing provides a hashing function H that can be applied to each token aᵢ in A. The result of H(aᵢ) buckets/partitions A⊥{A₁, A₂, A₃, . . . . Aₘ} so that ∀<aᵢ, aⱼ>∈Aᵢ×Aᵢ, D(aᵢ, aⱼ)<d_{threshold}, with probability p. That is, the hashing function H( ) groups together tokens that are similar according to the distance function. When provided with a new token aᵢ (the target token), applying H(aᵢ) produces a result figure which is used to determine which of the {A₁, A₂, A₃, . . . . Aₘ} contains a token similar to aᵢ.

For the most part, Location Sensitive Hashing methods have been applied to much larger data objects than short tokens, being used for tasks such as plagiarism detection (the distance function in this application is the number of word or phrases shared between documents), gene sequence similarity (where the distance function is the number of common base-pair sequences) or digital data similarity (where the distance function is the probability that two digital data objects share some physical byte sequence). In these use-cases the standard approach is to:
Divide, or “shingle,” each input sequence of bytes into (possibly overlapping) subsequences;
Apply a function to each subsequence to generate a characteristic value for each shingle;
Use a method like minHash to create a summary or profile of the contents of the input sequence by combining the characteristic value for each of its shingles; and
Compare two of these minHash profiles to compute a similarity metric along the lines of P (byte sequence in Input 1|byte sequence in Input_2).

The approximate search problem addressed herein differs from mainstream applications of LSH methods because it concerns short data objects rather than large byte sequences. The use of LSH to perform approximate search in data elements comprising short string or tokens is outlined below:
1. Starting with a long list of Data Elements referred to as E, label each Data Element E₁, E₂ . . . , etc. Each individual Data Element Eᵢ contains a (smallish . . . <10) set of tokens. An individual token may be present in multiple Data Elements.
2. Combine all of the tokens in all of the Data Elements into a long list of <token, Data Element ID> pairs. That is, {<aᵢ, Eᵢ>} pairs.
3. For each aᵢ run H(aᵢ) and partition {<aᵢ, Eᵢ>} into AE₁, AE₂, etc, so that ∀<aᵢ, aⱼ>∈AEᵢ×AEᵢ, H(aᵢ)=H(aⱼ) and D(aᵢ, aⱼ)<d_{threshold}, with probability p.
4. Then, given a target aᵢ, run H(aᵢ) and find the AEᵢ where H(aᵢ∈AEᵢ)=H(aᵢ), which in turn yields a list of Data Elements that contain a token that is similar or close to aᵢ.

The approximate search process presented immediately above differs slightly from the process illustrated in FIG. 3, discussed above. In FIG. 3, the list of data strings/tokens is drawn from one data element or column within a database table; whereas, in the process steps recited above, this list of data strings/tokens comprises a list of token and data element pairs.

The challenge here, is to compose an FSH hashing function H(aᵢ) for short strings that will guarantee “D(aᵢ, aⱼ)<d_{threshold}, with probability p” in step 3 above.

### Locality Sensitive Hashing Method for Short Strings/Tokens:

The FSH hashing function should include close transliterations of target tokens in the partition associated with H(aᵢ). The best metric by which to measure string closeness in transliteration space is Edit Distance, which is the number of individual character deletions and insertions required to change one string into another. Thus, Edit_Distance (“foo”, “foo”)=0, Edit_Distance (“foo”, “fo”)=1, and Edit_Distance (“foo”, “bar”)=3. Edit_Distance (aᵢ, aⱼ) can be calculated from the number of characters in the input string.

Two important properties of Edit_Distance are:
(1) If a common subsequence cs of two input strings aᵢ and aⱼ can be found, then the upper bound on Edit Distance is |aᵢ|+|aⱼ|−2×|cs|.
Example 1: if aᵢ=“abcdefghi”, and aⱼ=“uvwdefxyz”, then “def” is a common subsequence with length=3. |aᵢ|=|aⱼ|=9, so the upper bound on Edit_Distance=9+9−2×3=12. This is simply “delete the first three and the last characters from one token, and insert the corresponding first three and the last three characters from the other.” In this case the upper bound happens to be the same as the actual Edit Distance.
Example 2: aᵢ=“abcdefghpqijk” with length=13, and aj=“uvdefxypqz” with length=10. “def” and “pq” are both common subsequences of aᵢ and aⱼ. For the purposes of this example the length of “pq” is chosen to be length=2, and the an upper bound on Edit Distance is calculated to be (13+10)−(2×2)=19. Note however, that because there is another common subsequence “def”, the actual Edit Distance is less than 19.
(2) As the number of deletes/inserts required to convert the cs to itself is zero, if any cs is deleted from both inputs, the Edit_Distance can then be computed by finding the sum of the Edit_Distance for characters before the deleted cs in both input strings with the Edit_Distance for characters after the deleted les in both input strings.
Example 3: looking again at aᵢ=“abcdefghpqijk” and aⱼ=“uvdefxypqz”. Removal of the “pq” common subsequence aᵢ and aⱼ leaves a pair of “before cs=‘pq’” and “after cs=‘pq’” strings. As it happens, the “before cs=‘pq’” strings also have a common sequence of “def” and this method may be applied in a recursive manner to produce a pair of “before cs=‘def’” and “after cs=‘def’” strings. The table below shows the overall procedure.

TABLE 1
“abcdefgh | pq |ijk”
“uvdefxy | pq | z”

| “abc \| def \| gh” | | | “ljk” |
|---|---|---|---|
| “uv \| def \| xy” | | | “z” |
| | “abc” | “gh” | |
| | “uv” | “xy” | |

An examination of the remains of aᵢ and aⱼ after all common subsequences have been removed will yield the upper bound on Edit Distance as simply a count of remaining characters. Ideally then, H(aᵢ) and H(aⱼ) should produce results from which all common subsequences of aᵢ and aⱼ can be determined as the precise Edit_Distance (aᵢ, aⱼ) can be calculated.

The best way to represent all common subsequences of aᵢ and aⱼ would be to use aᵢ and aⱼ themselves as hash values, but that would be too precise for the current purposes. A single character difference between aᵢ and aⱼ would result in very different H(aᵢ) and H(aⱼ) results. For similar reasons, recording all of an input token's subsequences in the H(aᵢ) result is undesirable, as a single transliteration of a single character in aᵢ would change this list, it is desired that such single character transliterations end up in the same H(aᵢ) bucket with high probability. Tokens which are close in their character composition should share the same H(aᵢ) result.

The novel FSH hashing function H(aᵢ) presented herein characterizes the contents of a token like aᵢ through H(aᵢ) in terms of an ordered list of its common bigrams. The sixteen most common bigrams in English, together with the percentage of character pairs that actually are this bigram, are listed in order 0-15 in the following table.

### Bigram Frequency in the English Language

TABLE 2

| | Bigram | Percentage |
|---|---|---|
| 0 | “TH” | 3.56% |
| 1 | “HE” | 3.07% |
| 2 | “IN” | 2.43% |
| 3 | “ER” | 2.05% |
| 4 | “AN” | 1.99% |
| 5 | “RE” | 1.85% |
| 6 | “ON” | 1.76% |
| 7 | “AT” | 1.49% |
| 8 | “EN” | 1.45% |
| 9 | “ND” | 1.35% |
| 10 | “TI” | 1.34% |
| 11 | “ES” | 1.34% |
| 12 | “OR” | 1.28% |
| 13 | “TE” | 1.2% |
| 14 | “OF” | 1.17% |
| 15 | “ED” | 1.17% |

The probability that any pair of characters, chosen at random from a token, is one of these bigrams equals about 0.3. If a token has 8 letters, then it has 7 bigrams, and the probability that at least one of these bigrams appears is (1.0−(1.0−0.3))≅0.9, and the probability that at least two of these bigrams appear in the token is about 0.66. Given a 32-bit integer, there is enough space to hold the first eight bigrams. Note that by doubling the number of bigrams to 32, six bigrams can be held in a 32-bit integer, which improves the odds that a random bigram is one of the 32 most common bigrams to 0.44, means the probability that one of these appears is (1.0−(1.0−0.44))≅0.98, and the probability that at least 2 appear is 0.88.

Each of these 32 bigrams can be identified with 5 bits. Then the H(aᵢ) function would produce as output an array of bigram identifiers (bottom row—16, 5, 6), as follows:

| O | R | E | G | O | N |
|---|---|---|---|---|---|
| “OR” = 12 | “RE” = 5 | “EG” = N/A | “GO” = N/A | “ON” = 6 | |
| 12 | 5 | 6 | 0 | 6 | 0 |

Most single-character transliterations of this string will yield the same H(aᵢ) result. There are seven places to insert a character into the token “OREGON”. Out of these seven transliterations, only two yield different H(aᵢ) results. Out of the six characters in the token deleting or substituting two of them—{“E”, “G”}—will also not change the H(aᵢ) result. The four transliterations of “OREGON” shown below, each including the character “T” inserted at differing locations, are seen to produce the same H(aᵢ) result (bigram identifiers 12, 5, 6) as produced from the token “OREGON.”

| T | O | R | E | G | O | N |
|---|---|---|---|---|---|---|
| “TO” = N/A | “OR” = 12 | “RE” = 5 | “EG” = N/A | “GO” = N/A | “ON” = 6 | . . . |
| 12 | 5 | 6 | 0 | 0 | 0 | 0 |

| O | R | E | T | G | O | N |
|---|---|---|---|---|---|---|
| “OR” = 12 | “RE” = 5 | “ET” = N/A | “TG” = N/A | “GO” = N/A | “ON” = 6 | . . . |
| 12 | 5 | 6 | 0 | 0 | 0 | 0 |

| O | R | E | G | T | O | N |
|---|---|---|---|---|---|---|
| “OR” = 12 | “RE” = 5 | “EG” = N/A | “GT” = N/A | “TO”-N/A | “ON” = 6 | . . . |
| 12 | 5 | 6 | 0 | 0 | 0 | 0 |

| O | R | E | G | O | N | T |
|---|---|---|---|---|---|---|
| “OR” = 12 | “RE” = 5 | “EG” = N/A | “GO” = N/A | “ON” = 6 | . . . | . . . |
| 12 | 6 | 5 | 0 | 0 | 0 | 0 |

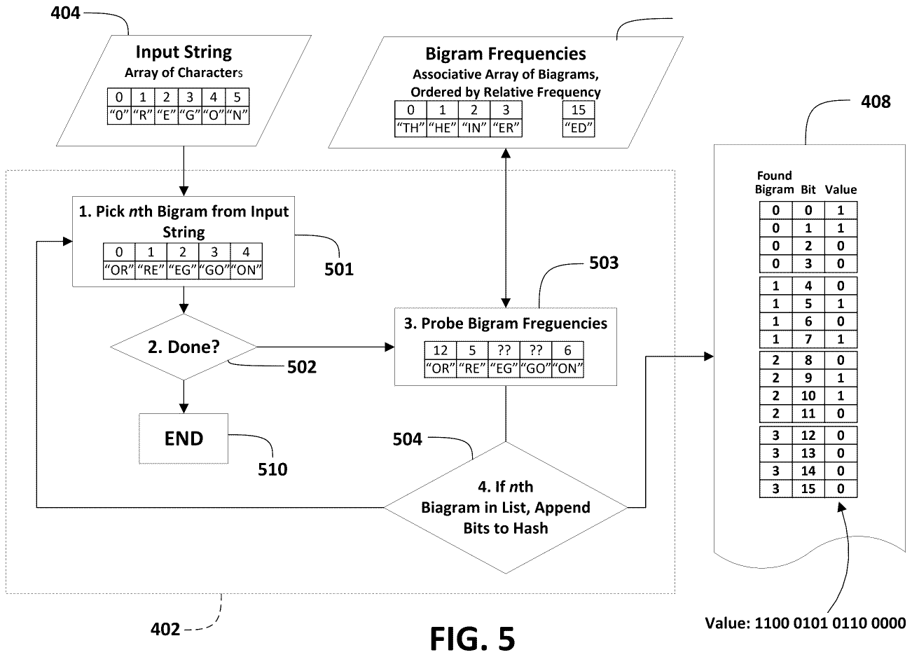

FIG. 5 provides a flow diagram illustrating the structure and operation of a LSH 402 and utilization of a bigram table frequency table 406 to generate a hash value 408 for a short string or token 402. In this illustration, input string 404 comprises the six characters forming the word “OREGON.” Bigram frequency table 406 comprises an array of fifteen bigrams ordered by relativity from 0 to 15. This array may be the bigrams from “TH” to “ED” included in Table 2 shown and discussed above. Each bigram in table 406 has an associated value, in this example the value of a bigram is equivalent to the frequency order in the table, e.g., “OR” has a value of 12, “RE” has a value 5, and “EG” has a value of 6.

Input stream 402 is received by LSH 402, and the bigrams included in the income stream, in this example the five bigrams “OR,” “RE,” “EG,” “GO,” and “ON,” are successively processed as shown in steps 501 through 504 until the last bigram from input stream 404 has been examined and the process ends at step 510.

In step 501, a bigram is selected from the input string for processing. Step 502 determines if all input stream bigrams have been processed. Bigrams to be evaluated are sent to step 503, where the received bigram is compared to bigram frequency table 406 to identify any matching bigram. If a match is found, the value of the matching bigram is returned, the value of the matching bigram forming part of the hash value 406 generated by the LSH function in step 504.

The sequence for processing bigrams in this example is “OR,” “RE,” “EG,” “GO,” and “ON.” The LSH processing of the string “OREGON” identifies the three bigrams “OR,” “RE,” and “ON” as being included in bigram frequency table 406. When processing has been completed, the values 12, 5, and 6, corresponding to bigrams “OR,” “RE,” and “ON,” will have been returned from table 406. No values will be returned for bigrams “EG” and “GO” as they are not included in bigram frequency table 406. The output hash value in this example is the eight-byte value 1100 0101 0110 0000 0000 0000 0000 0000 where byte 1110=12, byte 0101=5, and byte 0110=6, and trailing zeros have been added to fill thirty-two bits.

Pseudo-code for this procedure is as follows:

| | |
|---|---|
| function ngram_lsh ( | string : input_string, |
| | array : input_ngram_distribution ) |

returns integer
bytes : return_value[ ] = 0;

| | | |
|---|---|---|
| integer: | result_offset | = 0; |
| integer: | string_offset | = 0; |
| integer: | bigram_index | = 0; |

```
  char: current_bigram[2] = “”;
  loop:
    current_bigram = sub_string ( input_string,
    string_offset, 2);
    //
    // If there aren't enough letters left in the
    // input_string to constitute a bigram, break out of the
    // loop.
    if 2 < length ( current_bigram ):
      break loop;
    bigram_index = probe_distribution
```

( input_ngram_distribution, current_bigram );

```
    //
    // If the probe_distribution( ) finds that the
    //current_bigram is in the input_ngram_distribution
    // list, it returns a value that is > 0.
    if (0 < bigram_index):
      return_value [ result_offset ] = bigram_index;
      result_offset = result_offset + 1;
    end loop
    return cast(return_value as integer);
end
```

Note that although the novel LSH hashing process introduced here is not used to compute Edit_Distance, this property of the bigram hashing function is relied upon to interpret the relationships between values that hash into a single bucket. From an analytic perspective, tokens which hash to the same bucket will always be closer, relatively speaking, than tokens hashing to separate buckets.

In the LSH hashing process illustrated in FIG. 5, and discussed above, bigram frequency table 406 includes an array of the sixteen most frequently encountered bigrams in the English language. The value associated with each bigram in table 406 corresponds to the placement by frequency of each bigram in the array. However, this number of bigrams in table 406 is not limited to sixteen, and the list may be expanded to include more than sixteen bigrams and associated values. For example, the list of bigrams may be expanded to include the thirty-two most frequent, sixty-four most frequent, 128 most frequent bigrams, or any other number of bigrams. This list need not be a listing of most frequent bigrams in the English language, and instead could be a list of the most frequently appearing bigrams within the data elements and strings included in database or data store being searched. The values associated with the bigrams in table 406 may also be determined other than by frequency placement.

The hash value generated by the LSH process of FIG. 5 is shown to be an eight-byte binary value, or thirty-two bit output, wherein each bigram in the input string found in table 406 contributes one byte (four bits) to the output hash value. The composition and length of the output hash value may change with the number of bigrams listed in table 406, For example, in a listing containing thirty-two bigrams ordered by relative frequency, each bigram in the input string found in table 406 will require five bits of the output hash value. An array with the sixty-four most common bigrams will require six bits of the output hash value.

There may be situations when the token/string to be indexed contains none of the common bigrams contained in the bigram frequencies table. In such a case, the LSH process can be configured to perform an additional hash operation using a different (less frequent) list of bigrams.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A database system comprising:
at least one processor;
a table of common bigrams, each common bigram having a value associated therewith;
a non-transitory storage medium storing instructions executable on the at least one processor to:
in response to receipt of a character string by said database system, divide said character string into a series of bigrams;
for each bigram within said character string, perform a search of said table of common bigrams to identify a matching common bigram to said character string bigram;
retrieve from said table of common bigrams the values associated with each matching bigram; and
combine the retrieved values associated with each matching bigram to generate an output hash value for said character string.

2. The database system in accordance with claim 1, wherein
said bigram table comprises a list of common bigrams in the English vocabulary ordered by frequency of occurrence; and
the value associated with each common bigram corresponds to its order of occurrence in said list.

3. The database system in accordance with claim 1, wherein:
said character string comprises one of a plurality of character strings;
said non-transitory storage medium storing additional instructions executable on the one or more processors to:
generate output hash values for each one of said plurality of character strings; and
create a hash table wherein character strings which are similar are mapped together through their output hash values.

4. The database system in accordance with claim 3, wherein:
character streams which are similar are character streams that contain a single transliteration of one another.

5. The database system in accordance with claim 3, wherein:
said non-transitory storage medium storing additional instructions executable on the one or more processors to:
in response to receipt of a search character string by said database system; generate a hash value for said search character string; and
probe said hash table with said hash value for said search character string to identify character strings having the same hash value as said search character string.

6. A method of a database system comprising a processor, the method comprising the following steps performed by said processor:
in response to receipt of a character string by said database system, dividing said character string into a series of bigrams;
for each bigram within said character string, performing a search of a table of common bigrams to identify a matching common bigram to said character string bigram, each common bigram within said table having a value associated therewith;
retrieving from said table of common bigrams the values associated with each matching bigram; and
combining the retrieved values associated with each matching bigram to generate an output hash value for said character string.

7. The method in accordance with claim 6, wherein
said bigram table comprises a list of common bigrams in the English vocabulary ordered by frequency of occurrence; and
the value associated with each common bigram corresponds to its order of occurrence in said list.

8. The method in accordance with claim 6, wherein:
said character string comprises one of a plurality of character strings;
the method further comprising the following steps performed by said processor:
generating output hash values for each one of said plurality of character strings; and
creating a hash table wherein character strings which are similar are mapped together through their output hash values.

9. The method in accordance with claim 8, wherein:
character streams which are similar are character streams that contain a single transliteration of one another.

10. The method in accordance with claim 8, wherein the method further comprising the following steps performed by said processor:
in response to receipt of a search character string by said database system; generating a hash value for said search character string; and
probing said hash table with said hash value for said search character string to identify character strings having the same hash value as said search character string.

11. A method of a database system comprising a processor and a data storage, said data storage including a database table comprising at least one column including a plurality of target character strings, the method comprising the following steps performed by said processor:
for each one of said target character strings:
dividing said one of said target character strings into a series of bigrams;
for each bigram within said one of said target character strings, performing a search of a table of common bigrams to identify a matching common bigram to said character string bigram, each common bigram within said table having a value associated therewith;
retrieving from said table of common bigrams the values associated with each matching bigram;
combining the retrieved values associated with each matching bigram to generate an output hash value for said one of said target character strings; and
adding said output has value to a hash table wherein target character strings which are similar are mapped together through their output hash values;
in response to receipt of a search character string by said database system:
dividing said search character string into a series of bigrams;
for each bigram within said search character string, performing a search of a table of common bigrams to identify a matching common bigram to said character string bigram, each common bigram within said table having a value associated therewith;
retrieving from said table of common bigrams the values associated with each matching bigram; and
combining the retrieved values associated with each matching bigram to generate an output hash value for said search character string; and
probing said hash table with said hash value for said search character string to identify target character strings having the same hash value as said search character string.

12. The method in accordance with claim 11, wherein
said bigram table comprises a list of common bigrams in the English vocabulary ordered by frequency of occurrence; and
the value associated with each common bigram corresponds to its order of occurrence in said list.

13. The method in accordance with claim 11, wherein:
target character streams which are similar are target character streams that contain a single transliteration of one another.
